(19) United States
(12) Patent Application Publication
(10) Pub. No.: US 2025/0201992 A1
(43) Pub. Date: Jun. 19, 2025

(54) BATTERY MODULE/PACK FOR PRISMATIC BATTERY CELLS

(71) Applicant: GM GLOBAL TECHNOLOGY OPERATIONS LLC, Detroit, MI (US)

(72) Inventors: Diptak BHATTACHARYA, Royal Oak, MI (US); Thomas A. Yersak, Royal Oak, MI (US); Andrew Clay Bobel, Troy, MI (US); Xiaoling Chen, Sterling Heights, MI (US); Derek Frei Lahr, Ann Anbor, MI (US); Bradley Allen Newcomb, Troy, MI (US); Ryan Patrick Hickey, Austin, TX (US); Anil K. Sachdev, Rochester Hills, MI (US); Jordan Ladd, Royal Oak, MI (US)

(21) Appl. No.: 18/541,262

(22) Filed: Dec. 15, 2023

(51) Int. Cl. H01M 50/209; H01M 50/103; H01M 50/231; H01M 50/242; H01M 50/258; H01M 50/269; H01M 50/489

(52) U.S. Cl. CPC H01M 50/209; H01M 50/103; H01M 50/231; H01M 50/242; H01M 50/258; H01M 50/269; H01M 50/489; H01M 2220/10; H01M 2220/20

(57) ABSTRACT

A battery module/pack includes M prismatic battery cells each including a battery cell core. N barrier material layers are arranged between adjacent ones of the M prismatic battery cells, where M and N are integers greater than one. A first end plate includes a flat plate with a raised portion contacting a first side of a first one of the M prismatic battery cells. A second end plate includes a flat plate with a raised portion contacting a first side of a last one of the M prismatic battery cells. The raised portion of the first end plate is smaller in length and width than the first side of the first one of the M prismatic battery cells. The raised portion of the second end plate is smaller in length and width than the first side of the last one of the M prismatic battery cells.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery modules/packs, and more particularly to battery modules/packs for prismatic battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include one or more cathode electrodes, anode electrodes, and separators. The cathode electrodes include a cathode active material layer (including cathode active material) arranged on a cathode current collector. The anode electrodes include an anode active material layer (including anode active material) arranged on an anode current collector.

### SUMMARY

A battery module/pack includes M prismatic battery cells each including a battery cell core arranged in a prismatic enclosure. N barrier material layers are arranged between adjacent ones of the M prismatic battery cells, where M and N are integers greater than one. A first end plate includes a flat plate with a raised portion contacting a first side of a first one of the M prismatic battery cells. A second end plate includes a flat plate with a raised portion contacting a first side of a last one of the M prismatic battery cells. The raised portion of the first end plate is smaller in length and width than the first side of the first one of the M prismatic battery cells. The raised portion of the second end plate is smaller in length and width than the first side of the last one of the M prismatic battery cells.

In some examples, the N barrier material layers are smaller in length and width than sides of the M prismatic battery cells. The N barrier material layers have the same length and width as sides of the M prismatic battery cells. The N barrier material layers comprise aerogel. The N barrier material layers comprise foam. The raised portion of the first end plate has a rectangular cross section. A surface between edges of the first end plate and the raised portion is at least one of filleted, beveled, chamfered, and sloped. The raised portion includes a curved surface having a thickness that monotonically increases from first and second edges of the first end plate to a center of the first end plate.

In other features, the prismatic enclosure includes a lid, a bottom, wide faces, narrow faces, and edges therebetween. The raised portion has a length that is 7 mm to 20 mm shorter than a length between of the edges of the wide faces of the prismatic enclosure and a width that is 4 mm to 16 mm shorter than a width between the edges of the wide faces of the prismatic enclosure.

A battery module/pack comprises M prismatic battery cells each including a prismatic enclosure and a battery cell core. N barrier material layers are arranged between adjacent ones of the M prismatic battery cells, where M and N are integers greater than one. At least one of a first end plate and a second end plate includes an adjustable end plate including a plate including a cavity, a moveable plate arranged in the cavity, and an adjustment device configured to move the moveable plate relative to the plate, wherein the plate contacts a side of an outer one of the M prismatic battery cells.

In other features, the N barrier material layers are smaller in length and width than sides corresponding to wide faces of the M prismatic battery cells. The N barrier material layers have the same length and width as sides corresponding to wide faces of the M prismatic battery cells. The N barrier material layers comprise aerogel. The N barrier material layers comprise foam. The moveable plate has a length and width smaller than sides corresponding to wide faces of the prismatic enclosure.

In other features, the prismatic enclosure includes a lid, a bottom, narrow faces, wide faces, and edges between sides of the prismatic enclosure. The moveable plate has a length that is 7 mm to 20 mm shorter than a length between of the edges of the wide faces of the prismatic enclosure and a width that is 4 mm to 16 mm shorter than a width between the edges of the wide faces of the prismatic enclosure.

A battery module/pack includes M prismatic battery cells each including a prismatic enclosure and a battery cell core, wherein the prismatic enclosure includes a lid, a bottom, narrow faces, wide faces, and edges. N barrier material layers are arranged between adjacent ones of the M prismatic battery cells, where M and N are integers greater than one. The battery module/pack includes a first end plate and a second end plate. The N barrier material layers are smaller in length and width than the wide face of an outer one of the M prismatic battery cells.

In other features, the N barrier material layers comprise aerogel. The N barrier material layers comprise foam.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell including anode electrodes, cathode electrodes, and separators;

FIGS. 2A and 2B are perspective views of an example of a prismatic battery cell;

FIG. 3A is a graph illustrating an example of stress and strain for a pouch battery cell, a prismatic battery cell with pressure applied against edges thereof, and a prismatic cell with pressure applied inside from the edges according to the present disclosure;

FIG. 3B illustrates an example of application of pressure to a prismatic battery cell against edges thereof and inside of the edges according to the present disclosure;

FIG. 3C illustrates an example of compression of the prismatic battery cell against edges thereof and inside of the edges according to the present disclosure;

FIG. 4 is a side cross sectional view of an example of a battery module/pack including a plurality of battery cells, end plates and layers;

FIGS. 5A and 5B are side cross sectional views of examples of a battery module/pack including a plurality of battery cells, end plates with a raised portion, and layers according to the present disclosure;

FIGS. 5C and 5D are examples of end plates with raised portions according to the present disclosure;

FIGS. 6A and 6B are side cross sectional views of an example of an adjustable end plate according to the present disclosure;

FIG. 6C is a plan view of the adjustable end plate according to the present disclosure;

FIG. 7A is a side cross sectional view of an example of an end plate with a curved raised portion according to the present disclosure;

FIG. 7B is a perspective view illustrating an example of expansion of the battery cell along a side of the prismatic battery cell;

FIGS. 8A and 8B are side cross sectional views of other examples of end plates and layers located adjacent to a battery cell according to the present disclosure;

FIGS. 9A and 9B is a perspective view illustrating an example of a prismatic battery cell with a side including a recess to receive a layer according to the present disclosure; and

FIG. 10 is a side cross-sectional view of another example of a prismatic battery cell with a recessed portion according to the present disclosure.

In the drawings, reference numbers may be reused to identify similar and/or identical elements.

### DETAILED DESCRIPTION

While battery packs according to the present disclosure are shown in the context of electric vehicles, the battery packs can be used in stationary applications and/or other applications.

In a battery module/pack, a plurality of battery cells and intervening barrier material layers (e.g., foam, aerogel, or other material) or cooling channels are arranged in a predetermined order in a battery module/pack enclosure. End plates contact opposite ends of the plurality of battery cells. A battery module/pack enclosure applies pressure against the end plates to limit expansion of the battery cells. The battery cells are compressed between the end plates to prevent (or control) the expansion of the battery cells during cycling. Maintaining pressure of the battery cells increases performance and/or durability of the battery cells.

Battery cells are subject to expansion and swelling during cycling. The amount of swelling is determined by the chemistry of the battery cell. Expansion occurs reversibly from 0 to 100% state-of-charge (SOC) while swelling occurs irreversibly from beginning-of-life (BOL) to end-of-life (EOL). A core pressure is applied to the battery cells to manage expansion and swelling to ensure that the battery cells achieve adequate cycle life.

Battery cells are also subject to thermal runaway. The characteristics of thermal runaway (i.e. total heat release, duration, and peak temperature) are dictated by the chemistry of the battery cell, state-of-charge, operating conditions, and age. Battery systems are designed to prevent thermal runaway propagation (TRP) from cell-to-cell (C2C).

To manage cell expansion and prevent C2C TRP, current rechargeable energy storage system (RESS) designs utilize foam and aerogel interlayers between the battery cells. The purpose of the foam is to accommodate cell expansion while the purpose of the aerogel is to provide thermal insulation. Insulating parts are known as thermal runaway barriers (TRB). Aerogels serve a dual purpose in that they also accommodate cell expansion like the foam. Optionally, foams can be insulating as well.

The present disclosure provides various methods to efficiently apply compressive pressure on battery cell cores (e.g., a jelly roll) in prismatic battery cell enclosures in a prismatic battery module/pack. The prismatic battery cell enclosure is made of metal such as stainless steel and is stiff (unlike pouch battery cells with a thin flexible enclosure). For example, applying pressure on the pouch battery cells is relatively easy due to the flexible sides of the pouch enclosure. For example, sufficient pressure can be applied using flat endplates that directly compress the sides of the battery cell cores in each of the pouch battery cells.

However, applying pressure on the battery cell cores arranged in the prismatic battery cell enclosures is more difficult due to the stiff lid, bottom, and sides of the enclosure. When flat end plates are used against sides with the wide faces, the load is predominantly transferred to the edges (e.g., edges between sides with wide faces, a lid, a bottom, and sides with narrow faces) of the prismatic battery cell enclosure. The pressure is not applied efficiently to the battery cell cores located therein. Increasing the load to reach a suitable pressure level on the battery cell cores can crush (or buckle) the prismatic battery cell enclosure. Furthermore, the battery cell cores in the prismatic enclosure of the battery module/pack may have different applied pressures, which may lead to uneven aging and premature failure.

In some examples, the battery module/pack according to the present disclosure includes end plates including a rectangular flat plate and a raised portion on one side. The raised portion has a length and width smaller than a length and width of the prismatic battery cell enclosure. In some examples, the length and width of the rectangular flat plate (with optional rounded corners) is the same as the prismatic battery cells. The raised portion is smaller than the side surface to allow pressure transfer inwardly away from the edges. As a result, the pressure is applied to the battery cell cores rather than the edges of the prismatic battery cell enclosures. In some examples, the layers between the prismatic battery cells have a length and width that is the same as or smaller than a length and width of the prismatic battery cell enclosure.

In other examples, the end plates are the same size as the prismatic enclosures and the layers are smaller. In other examples, the end plates include adjustable end plates that can vary applied pressure.

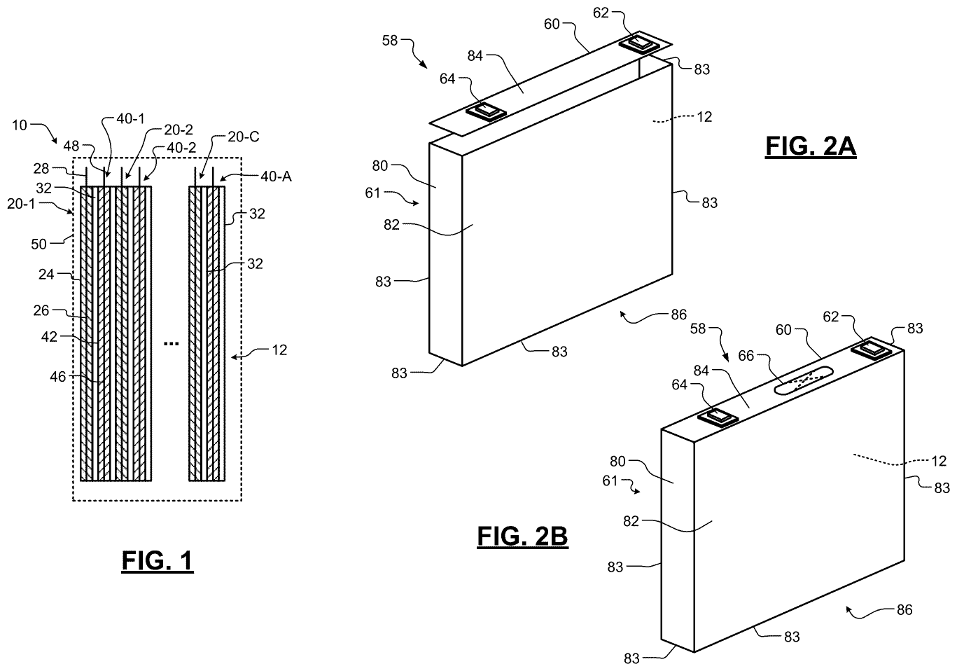

Referring now to FIG. 1, a battery cell 10 includes C cathode electrodes 20, A anode electrodes 40, and S separators 32 arranged in a predetermined sequence in a battery cell core 12, where C, S and A are integers greater than zero. The C cathode electrodes 20-1, 20-2, . . . , and 20-C include cathode active material layers 24 arranged on one or both sides of a cathode current collector 26.

In some examples, the A anode electrodes 40 and the C cathode electrodes 20 exchange lithium ions during charging/discharging. The A anode electrodes 40-1, 40-2, . . . , and 40-A include anode active material layers 42 arranged on one or both sides of the anode current collectors 46. In some examples, the cathode active material layers 24 and/or the anode active material layers 42 comprise coatings including one or more active materials, one or more conductive additives, and/or one or more binder materials that are applied to the current collectors (e.g., using a wet or dry roll-to-roll process).

In some examples, the cathode current collector 26 and/or the anode current collector 46 comprises metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell core 12. The external tabs 28 and 48 are connected to terminals of the battery cells.

Referring now to FIGS. 2A and 2B, a battery cell 58 includes an enclosure 60. In some examples, the enclosure 60 has a prismatic shape with rectangular cross-sections in x-, y- and z-axis planes. In some examples, the enclosure 60 includes an enclosure body 61 including sides 80 corresponding to narrow faces and sides 82 corresponding to wide faces. The enclosure body 61 defines an open-ended rectangular prism. In some examples, the enclosure 60 includes a lid portion 84 and a bottom portion 86. In other examples, the bottom portion 86 is attached after the enclosure 60 is formed. Edges 83 are arranged between the sides 80 and 82, the sides 80 and 82 and a lid portion 84, the sides 80 and 82 and the bottom portion 86.

The lid portion 84 and optionally the bottom portion 86 are attached to the enclosure body 61 to enclose top and the bottom openings of the enclosure body 61, respectively. The battery cell 58 includes external terminals 62 and 64 that pass through the lid portion 84. The battery cell core 12 of the C cathode electrodes 20, the A anode electrodes 40, and the S separators 32 is arranged in the enclosure 60.

The external terminals 62 and 64 are connected to external tabs 28 and 48 of the C cathode electrodes 20 and the A anode electrodes 40, respectively. In FIG. 2A, the lid portion 84 does not include a pressure-based vent cap. In FIG. 2B, the lid portion 84 (and/or the bottom portion 86) includes a pressure-based vent cap 66. The pressure-based vent cap 66 is configured to release vent gases when pressure within the inner enclosure is greater than a predetermined pressure.

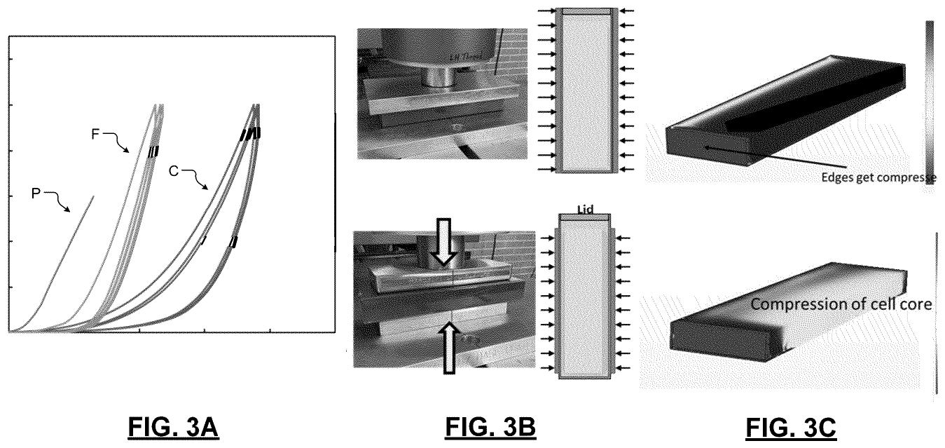

Referring now to FIGS. 3A to 3C, compression of a pouch battery cell (P) is compared to loading of a prismatic battery cell (F) against edges thereof and loading of an area inside edges of the prismatic battery cell (C). In FIG. 3A, stress and strain for a pouch battery cell are shown. Since the pouch battery cell does not have hard edges, the compressive force is transferred directly to the battery cell core.

When a load is applied to edges of a prismatic battery cell, the load is transferred to the edges of the prismatic battery cell enclosure and significantly less compressive force is applied to the battery cell core inside the prismatic battery cell. When the load is applied to an area inside of the edges of the prismatic battery cell enclosure, the load is more efficiently transferred to the battery cell core. In FIG. 3B, application of a load to the edges of the prismatic battery cell and inside of the edges is shown. In FIG. 3C, it can be seen that applying the load to the edges of the prismatic battery cells transfers no effective force on the battery cell core. Applying the load inside of the edges transfers higher compressive force to the battery cell core.

Referring now to FIG. 4, a battery module/pack 100 includes end plates 110 and 112, prismatic battery cells 114-1, 114-2, . . . and 114-M, and layers 116-1, 116-2, . . . , and 116-N, where M and N are integers greater than one. The end plates 110 and 112 and the layer 116-1, 116-2, . . . , and 116-N are typically the same size (length and width) as the prismatic battery cells 114-1, 114-2, . . . and 114-M. As a result, when compressing the end plates 110 and 112, the load is transferred to the edges of the prismatic battery cells 114-1, 114-2, . . . and 114-M rather than to the battery cell cores inside of the prismatic battery cells 114-1, 114-2, . . . and 114-M. In some examples, the battery module/pack 100 includes a module/pack enclosure 120 with a cover 122 and a bottom portion 124, although other types of enclosures can be used. The module/pack enclosure 120 biases the end plates 110 and 112 to maintain pressure.

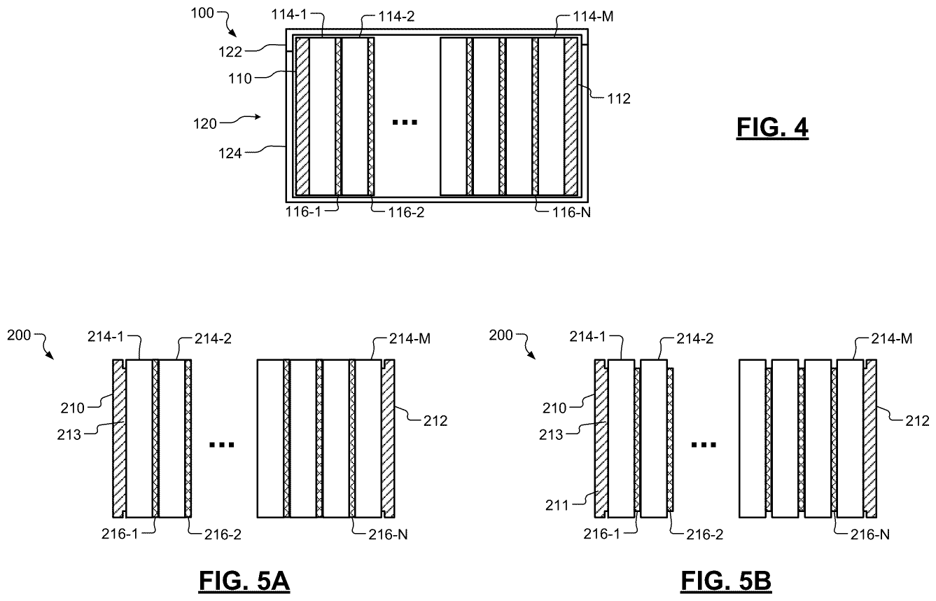

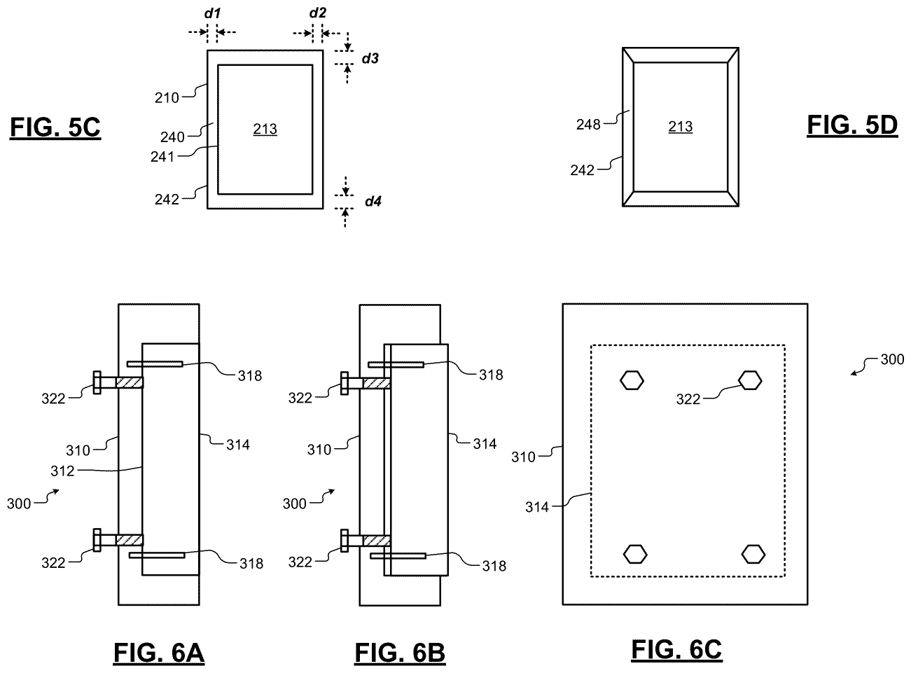

Referring now to FIGS. 5A and 5B, a battery module/pack 200 includes end plates 210 and 212, prismatic battery cells 214-1, 214-2, . . . and 214-M, and layers 216-1, 216-2, . . . , and 216-N, where M and N are integers greater than one. The end plates 210 and 212 include a planar portion 211 located adjacent to a raised portion 213 that has a smaller area (e.g., width and length) than the prismatic battery cells 214-1, 214-2, . . . and 214-M. In some examples, the raised portion 213 includes a planar surface that contacts a side of one of the prismatic battery cells 214.

In FIG. 5A, the layers 216-1, 216-2, . . . , and 216-N has the same width and length as a side of the prismatic battery cells 214-1, 214-2, . . . and 214-M. In FIG. 5B, the layer 216-1, 216-2, . . . , and 216-N has a smaller width and length than the sides of the prismatic battery cells 214-1, 214-2, . . . and 214-M to avoid the edges. When compressing the end plates 210 and 212, the load is primarily transferred to the battery cell cores inside of the prismatic battery cells 214-1, 214-2, . . . and 214-M rather than to the edges.

Referring now to FIGS. 5C and 5D, examples of end plates are shown. In FIG. 5C, an inner surface 240 is arranged parallel to a side of the prismatic battery cell. The inner surface 240 extends from edges 242 of the prismatic battery cell enclosure to a side portion 241 of the raised portion 213. In some examples, the raised portion 213 includes a raised rectangular section with rounded corners having a length and width matching length and width of the electrodes to apply even pressure across the electrodes. In this example, the inner surface 240 has a rectangular frame shape. The side portion 241 is arranged transverse to the inner surface 240 and the raised portion 213. In FIG. 5D, an inner surface 248 extends at an acute angle relative to the raised portion 213 and a side surface of the prismatic battery cell.

As can be appreciated, the area of the layer that is needed between each of the prismatic battery cells can be same as the sides of the prismatic battery cells or a reduced area can be used (which reduces cost by reducing material usage). In some examples, the layers are attached to the sides of the prismatic enclosures using adhesive. In other examples, spacers are used. The end plates and/or layer help to ensure that the applied pressure is concentrated on the battery cell cores in the prismatic enclosures (rather than on the edges).

In some examples, the raised portion 213 has a length that is 7 mm to 20 mm (e.g., 5 to 10 mm from the lid and 2 to 5 mm from the bottom) shorter than a length of the side 82 between edges 83 at the lid and the bottom of the prismatic enclosure and a width that is 4 mm to 16 mm shorter than a width of the side 82 of the prismatic enclosure (e.g., 2 to 8 mm from edges 83 between of the sides 80 and 82).

Referring now to FIGS. 6A and 6B, the end plates can be adjustable end plates providing variable compressive force. In FIG. 6A, an end plate 300 includes a rectangular plate 310 including a cavity 312 defined on one side thereof. An inner plate 314 is reciprocally received in the cavity 312. In some examples, the inner plate 314 includes rounded corners. Guide pins 318 can be inserted into bores on facing surfaces of the rectangular plate 310 in the cavity 312 and the inner plate 314. An adjustment device 322 moves the inner plate 314 relative to the rectangular plate 310. For example, the adjustment device 322 may include three or more bolts (e.g., 4 bolts) that are rotated to adjust the amount of movement of the inner plate 314 relative to the rectangular plate 310 to vary the amount of compressive force to the battery cell cores in the prismatic battery cell enclosures. The length and width of the inner plate are less than the length and width of the prismatic battery cell enclosures to ensure transfer of the load to the battery cell cores in the prismatic battery cell enclosures. In FIG. 6C, the rectangular plate 310 and the adjustment devices 322 are shown.

In some examples, the moveable plate has a length that is 7 mm to 20 mm shorter than a length between the lid and the bottom of the prismatic enclosure and a width that is 4 mm to 16 mm shorter than a width between the edges of the prismatic enclosure.

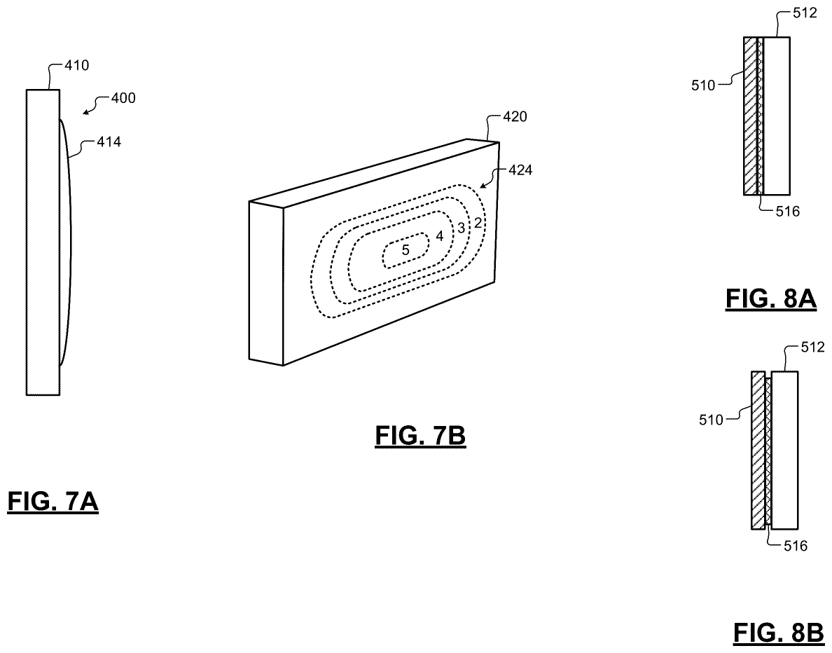

Referring now to FIG. 7A, another example of an end plate 400 is shown to include a rectangular plate 410 and a curved raised portion 414 on one side thereof. The curved raised portion 414 varies in thickness to a middle of the prismatic battery cell enclosure to vary the load on the side of the prismatic battery cell enclosure. In some examples, the curved raised portion has a monotonically increasing thickness from the edges to the middle. In FIG. 7B, a desired load profile shows swelling of sides of the prismatic enclosure in mm. The swelling monotonically increases from edges to the middle of the sides.

During cycling, sides of the prismatic enclosure expand up to 5 mm during cycling as shown in FIG. 7B. (considering 100 KPa internal pressure). A deformation profile indicates a displacement gradient from the center to the edges. The sides of the prismatic enclosure near the edges experience little to no swelling. The center of the sides expand the most. The curved raised portion has a profile that varies in one or more axes to match the deformation profile of the prismatic enclosure. In other words, the curved raised portion is thickest at the center where the prismatic enclosure swells the most and thinnest near the edges where the prismatic enclosure swells the least. This will ensure that the sides of the prismatic enclosure maintain contact with the end plate during swelling to maintain uniform pressure on the battery cell cores.

Referring now to FIGS. 8A and 8B, another example of an end plate 510 is shown. The end plate 510 includes a rectangular plate having a length and width equal to the prismatic battery cell enclosure. Layer 516 is arranged between the end plate 510 and a prismatic battery cell 512 or between adjacent prismatic battery cells 512. The layer 516 has a length and width the same as (FIG. 8A) or less than (FIG. 8B) the prismatic battery cell enclosure to transfer the load to the battery cell cores in the prismatic battery cells rather than to the edges of the prismatic battery cells.

Trimming the layer (e.g., aerogel) to dimensions smaller than the dimensions of the prismatic enclosures helps to concentrate pressure on the battery cell cores within the prismatic enclosures. For a given applied load on the end plate, more pressure is applied on the cell core when the layer avoids the stiff edges of the prismatic enclosure. In addition, lower loads can be applied on the endplates due to the improved efficiency of pressure transfer to the battery cell cores. As a result of the reduced load, thinner endplates can be used which reduces the mass of the battery pack/module. The smaller area of the layer reduces the cost of the layer. Replacement of a portion of the layer (e.g., aerogel) with air will not affect general heat transfer behavior during thermal runaway when the vent gases do not have access to the region where the aerogel is replaced by air.

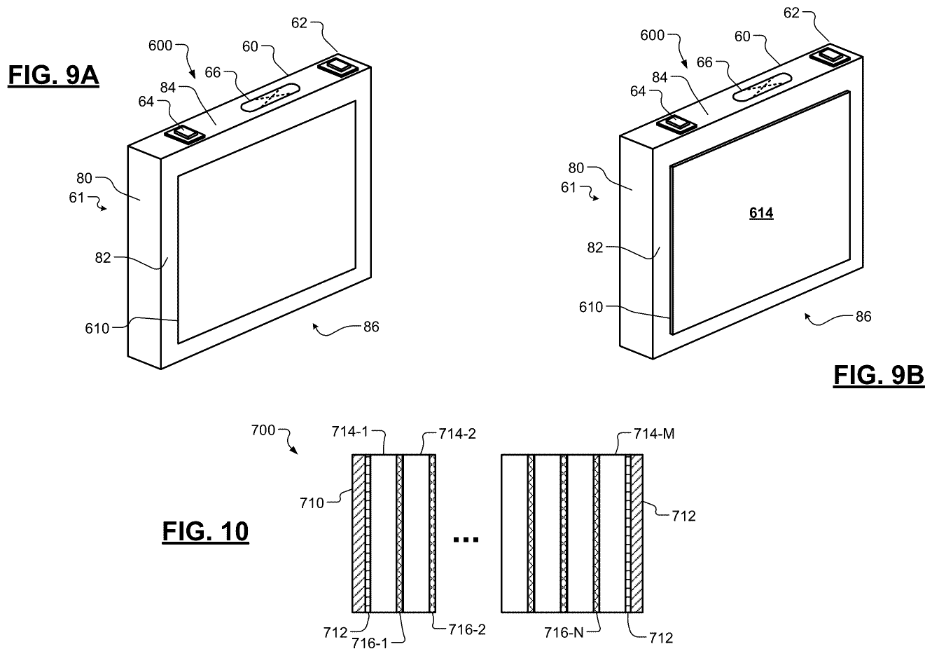

Referring now to FIGS. 9A and 9B, a prismatic battery cell 600 includes sides 82 including a recessed portion 610. The recessed portion 610 is located inside of edges of the enclosure body 61 to transfer compressive force to the battery cell cores. The recessed portion 610 has a depth of less than ½ of a thickness of layer 614 arranged therein. The layer 614 is also arranged in the recessed portion of the adjacent to prismatic battery cell. The recessed portion 610 helps to retain a position of the layer relative to the battery cell core. In some examples, edges of the recessed portion 610 are aligned with edges of the electrodes of the battery cell cores.

Referring now to FIG. 10, a battery module/pack 700 including end plates 710 and 711, prismatic battery cells 714-1, 714-2, . . . and 714-M, and layer 716-1, 716-2, . . . , and 716-N, where M and N are integers greater than one. A first material 712 is arranged between the end plates 710 and 711. In some examples, the end plates 710 and 711, the first material 712, and the layer 716-1, 716-2, . . . , and 716-N are the same size (length and width) as the prismatic battery cells 714-1, 714-2, . . . and 714-M. In other examples, the end plates 710 and 711, the first material 712, and the layer 716-1, 716-2, . . . , and 716-N are smaller than the prismatic enclosures of the prismatic battery cells 714-1, 714-2, . . . and 714-M.

In some examples, the first material 712 comprises a compliant material such as a foam layer. In prior battery module/pack designs, the end plates make direct contact with sides of the first and last prismatic can cells. Since the end plate is rigid, the load is transferred to the can cell through the stiff edges only at battery beginning of life (BOL). Addition of a compliant foam layer between the endplates and the sides of the first and last prismatic enclosures enables distribution of load to the battery cell cores. This approach ensures that all of the prismatic enclosures have the same fixturing condition, which prevents uneven cell aging and premature module failure.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery module/pack comprising:
M prismatic battery cells each including a battery cell core arranged in a prismatic enclosure;
N barrier material layers arranged between adjacent ones of the M prismatic battery cells, where M and N are integers greater than one;
a first end plate including a flat plate with a raised portion contacting a first side of a first one of the M prismatic battery cells; and
a second end plate including a flat plate with a raised portion contacting a first side of a last one of the M prismatic battery cells,
wherein the raised portion of the first end plate is smaller in length and width than the first side of the first one of the M prismatic battery cells, and
wherein the raised portion of the second end plate is smaller in length and width than the first side of the last one of the M prismatic battery cells.

2. The battery module/pack of claim 1, wherein the N barrier material layers are smaller in length and width than sides of the M prismatic battery cells.

3. The battery module/pack of claim 1, wherein the N barrier material layers have the same length and width as sides of the M prismatic battery cells.

4. The battery module/pack of claim 1, wherein the N barrier material layers comprise aerogel.

5. The battery module/pack of claim 1, wherein the N barrier material layers comprise foam.

6. The battery module/pack of claim 1, wherein the raised portion of the first end plate has a rectangular cross section.

7. The battery module/pack of claim 1, wherein a surface between edges of the first end plate and the raised portion is at least one of filleted, beveled, chamfered, and sloped.

8. The battery module/pack of claim 1, wherein the raised portion includes a curved surface having a thickness that monotonically increases from first and second edges of the first end plate to a center of the first end plate.

9. The battery module/pack of claim 1, wherein:
the prismatic enclosure includes a lid, a bottom, wide faces, narrow faces, and edges therebetween, and
the raised portion has a length that is 7 mm to 20 mm shorter than a length between of the edges of the wide faces of the prismatic enclosure and a width that is 4 mm to 16 mm shorter than a width between the edges of the wide faces of the prismatic enclosure.

10. A battery module/pack comprising:
M prismatic battery cells each including a prismatic enclosure and a battery cell core;
N barrier material layers arranged between adjacent ones of the M prismatic battery cells, where M and N are integers greater than one;
a first end plate; and
a second end plate,
wherein at least one of the first end plate and the second end plate includes an adjustable end plate including a plate including a cavity, a moveable plate arranged in the cavity, and an adjustment device configured to move the moveable plate relative to the plate, wherein the plate contacts a side of an outer one of the M prismatic battery cells.

11. The battery module/pack of claim 10, wherein the N barrier material layers are smaller in length and width than sides corresponding to wide faces of the M prismatic battery cells.

12. The battery module/pack of claim 10, wherein the N barrier material layers have the same length and width as sides corresponding to wide faces of the M prismatic battery cells.

13. The battery module/pack of claim 10, wherein the N barrier material layers comprise aerogel.

14. The battery module/pack of claim 10, wherein the N barrier material layers comprise foam.

15. The battery module/pack of claim 10, wherein the moveable plate has a length and width smaller than sides corresponding to wide faces of the prismatic enclosure.

16. The battery module/pack of claim 10, wherein:
the prismatic enclosure includes a lid, a bottom, narrow faces, wide faces, and edges between sides of the prismatic enclosure, and
the moveable plate has a length that is 7 mm to 20 mm shorter than a length between of the edges of the wide faces of the prismatic enclosure and a width that is 4 mm to 16 mm shorter than a width between the edges of the wide faces of the prismatic enclosure.

17. A battery module/pack comprising:
M prismatic battery cells each including a prismatic enclosure and a battery cell core, wherein the prismatic enclosure includes a lid, a bottom, narrow faces, wide faces, and edges;
N barrier material layers arranged between adjacent ones of the M prismatic battery cells, where M and N are integers greater than one;
a first end plate; and
a second end plate,
wherein the N barrier material layers are smaller in length and width than the wide face of an outer one of the M prismatic battery cells.

18. The battery module/pack of claim 17, wherein the N barrier material layers comprise aerogel.

19. The battery module/pack of claim 17, wherein the N barrier material layers comprise foam.
